(19) United States
(12) Patent Application Publication
(10) Pub. No.: US 2015/0217312 A1
(43) Pub. Date: Aug. 6, 2015

(54) ACCUMULATOR FOR AIRLESS SPRAYER

(71) Applicant: GRACO MINNESOTA INC., Minneapolis, MN (US)

(72) Inventors: Bradley H. Hines, Andover, MN (US); Mariusz J. Luczak, Elk River, MN (US)

(21) Appl. No.: 14/427,877

(22) PCT Filed: Sep. 12, 2013
(86) PCT No.: PCT/US2013/059441

§ 371 Date: Mar. 12, 2015

Related U.S. Application Data
(60) Provisional application No. 61/700,419, filed on Sep. 13, 2012.

(51) Int. Cl. B05B 9/04

(52) U.S. Cl. CPC B05B 9/0413; B05B 9/0426

(57) ABSTRACT

An airless fluid dispensing device comprises a reciprocating fluid pump, a drive element, a spray tip and an accumulator. The reciprocating fluid pump directly pressurizes a fluid. The drive element supplies power to the pump. The spray tip assembly is configured to receive pressurized fluid from the pump. The accumulator is located to be simultaneously pressurized by the reciprocating fluid pump as the spray tip assembly and configured to provide pressurized fluid to the spray tip assembly when the reciprocating fluid pump is at a changeover position.

### BACKGROUND

The present disclosure is related to liquid dispensing systems. In particular, the present disclosure relates to airless sprayers for dispensing paints, varnishes and the like.

Paint sprayers are well known and popular for use in painting of surfaces, such as on architectural structures, furniture and the like. Airless paint sprayers provide a high quality finish due to their ability to finely atomize liquids. Airless paint sprayers are typically coupled to a paint source, include a pumping mechanism that draws in the paint, and include a small, shaped orifice through which the paint is discharged. The pumping mechanisms are typically driven by a motor, which is actuated by an operator. Airless paint sprayers are capable of pressurizing liquid paint to upwards of 3,000 psi [pounds per square inch] (˜20.7 MPa). In order to achieve these pressures, typical pumping mechanisms utilize reciprocating pistons. The cycling of the pumping mechanism can produce pulsations within the pumped fluid. Spray quality of the pumped fluid can be diminished by pulsations, particularly when applying highly atomized paint for finishing projects.

Accumulators are one known method for mitigating effects of pulsations. An accumulator stores high-pressure fluid for release during a low-pressure movement of the pumping mechanism. In one design, an accumulator is integrated into the spray tip of a sprayer, as is described in U.S. Pat. No. 3,893,627 to Siczek et al, which is assigned to Graco Inc. Such a design increases the complexity of the spray tip and increases the amount of time needed for disassembly, cleaning and maintenance.

### SUMMARY

An airless fluid dispensing device comprises a reciprocating fluid pump, a drive element, a spray tip and an accumulator. The reciprocating fluid pump directly pressurizes a fluid. The drive element supplies power to the pump. The spray tip assembly is configured to receive pressurized fluid from the pump. The accumulator is located to be simultaneously pressurized by the reciprocating fluid pump as the spray tip assembly and configured to provide pressurized fluid to the spray tip assembly when the reciprocating fluid pump is at a changeover position.

The present disclosure is directed to an accumulator for use with a fluid dispensing device. In one embodiment, a hand held airless fluid dispensing device comprises a housing body, a fluid container, a pumping device, a primary drive element, a spray tip and an accumulator. The housing body is configured to be carried and supported by an operator of the hand held airless fluid dispensing device during operation. The fluid container is supported by the housing body. The pumping device is mounted to the housing body. The primary drive element is coupled to the housing body and connected to the pumping device to actuate the pumping device. The spray tip is connected to an outlet of the pumping device. The accumulator is disposed between the pumping device and the spray tip, the accumulator having a variable volume.

A detachable accumulator device comprises: a cylindrical housing defining an internal space, a closed end, and an open end; a piston disposed within the internal space and capable of extending to the open end; a flange extending from the piston; a spring disposed within the internal space and extending from the flange to the closed end; a seal disposed around the piston within the internal space and positioned between the open end and the flange; and a bushing surrounding the piston between the flange and the open end.

### BRIEF DESCRIPTION OF THE DRAWINGS

FIG. 1 is a perspective view of a portable airless sprayer including an accumulator.

FIG. 2 is a side cross-sectional view of a pumping mechanism and a spray tip assembly connected to a pump valve of the portable airless sprayer of FIG. 1.

FIG. 3 is a front a cross-sectional view of the pump valve of FIG. 2 connected to a control valve and an accumulator.

FIG. 4 is a cross-sectional view of an alternative embodiment of an accumulator for use with a portable airless sprayer.

### DETAILED DESCRIPTION

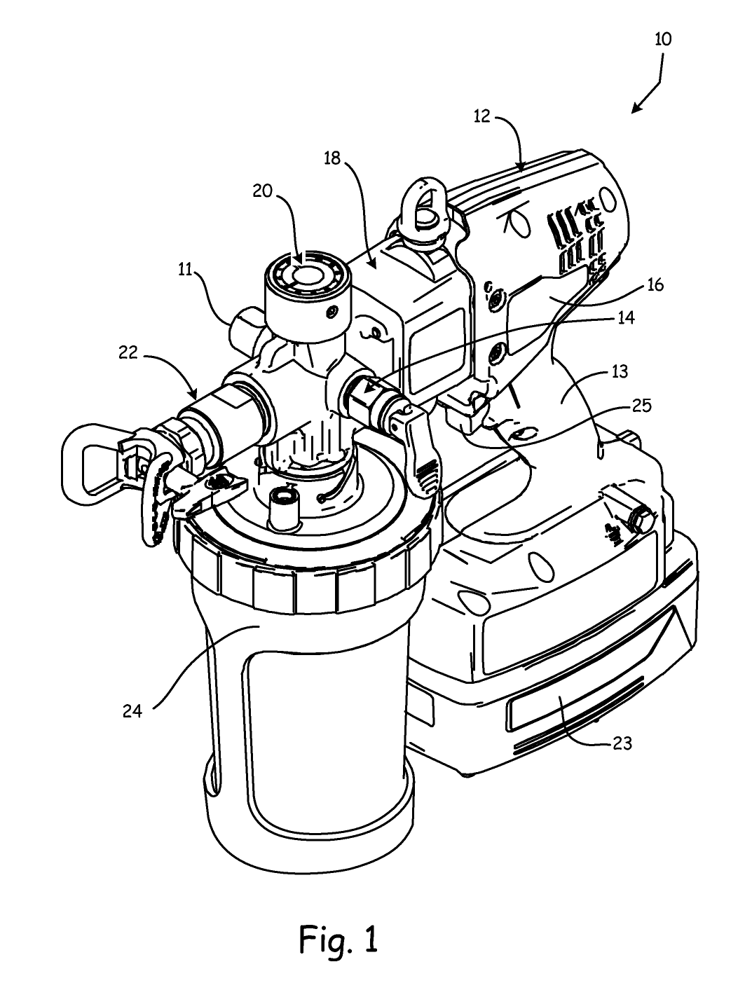

FIG. 1 is a perspective view of portable airless sprayer 10 in which an accumulator 11 is used. In the embodiment shown, portable airless sprayer 10 comprises accumulator 11, housing 12, pistol grip 13, control valve 14, drive element 16, pumping mechanism 18, pump valve 20, spray tip assembly 22, battery 23, fluid container 24 and trigger 25. The components of portable airless sprayer 10 are packaged together in an integrated handheld device that is fully carried and supported by an operator during use without connection to an external power source of fluid supply. However, in other embodiments, other types of spraying systems may be used with the accumulator.

Sprayer 10 comprises an airless dispensing system in which pumping mechanism 18 draws fluid from container 24 and, with power from drive element 16, pressurizes the fluid for atomization through spray tip assembly 22. Fluid container 24 is provided with a fluid that is desired to be sprayed from sprayer 10. For example, fluid container 24 is filled with a paint or varnish that is fed to spray tip assembly 22 through coupling with a lid of container 24. Battery 23 is plugged into a battery port connected to pistol grip 13 to provide power to drive element 16 within housing 12. Trigger 25 is connected to battery 23 and drive element 16 such that upon actuation of trigger 25 a power input is provided to pumping mechanism 18. Pumping mechanism 18 draws fluid from container 24 and provides pressurized fluid to spray tip assembly 22. Spray tip assembly 22 includes a spray orifice that receives pressurized fluid from pumping mechanism 18. Spray tip assembly 22 provides a highly atomized flow of fluid to produce a high quality finish.

Pumping mechanism 18 comprises, in different embodiments, a gear pump, a piston pump, a plunger pump, a vane pump, a rolling diaphragm pump, a ball pump, a rotary lobe pump, a diaphragm pump or a servo motor having a rack and pinion drive. Drive element 16 comprises, in different embodiments, an electric motor, an air-driven (pneumatic) motor, a linear actuator or a gas engine that can be used to drive a crankshaft, cams, a wobble plate or rocker arms. In the described embodiment, pumping mechanism 18 comprises a reciprocating piston pump and drive element 16 comprises a DC motor. In the various embodiments, pumping mechanism 18 generates orifice spray pressure, or running pressure, from about 360 pounds per square inch [psi] (˜2.48 MPa) up to about 3,000 psi (˜20.7 MPa), or higher.

Accumulator 11 provides an expandable volume that is pressurized by the pumping process to provide pressurized fluid to spray tip assembly 22 while pumping mechanism 18 is in a low pressure state. For the disclosed embodiment, accumulator 11 includes a spring-loaded volume that provides pressurized fluid while pistons of a reciprocating piston pumping device are at a change-over position.

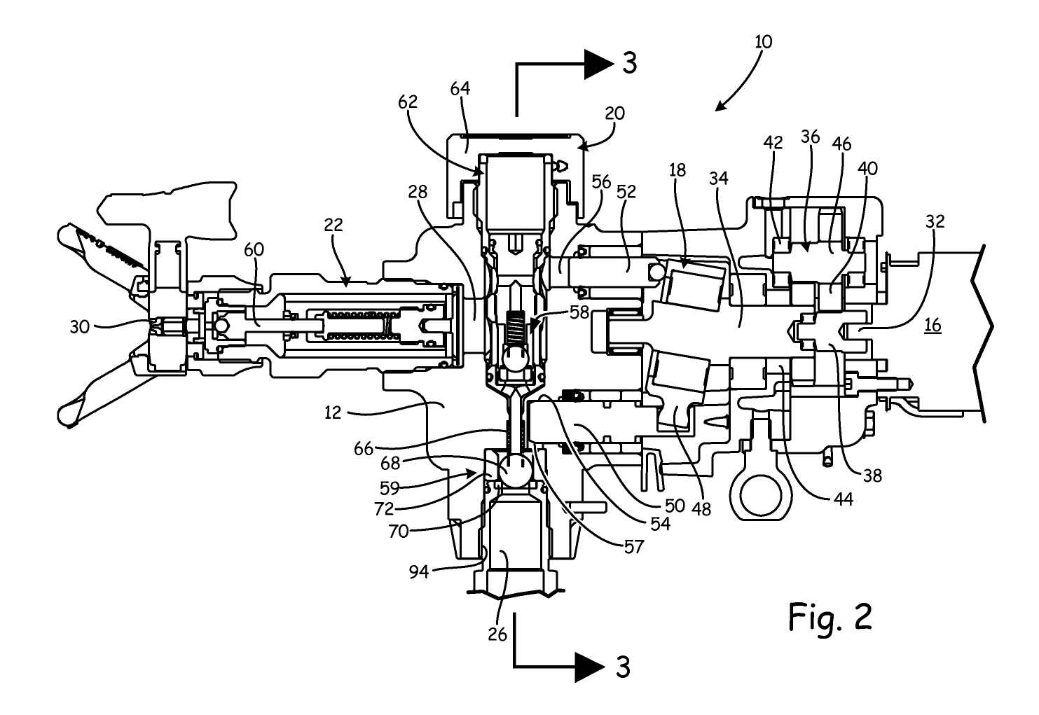

FIG. 2 is a schematic view of portable airless sprayer 10 including drive element 16, pumping mechanism 18, pump valve 20 and spray tip assembly 22. Drive element 16 provides power to pumping mechanism 18, which draws fluid into housing 12 at inlet tube 26 from fluid container 24 (FIG. 1). Pumping mechanism 18 pressurizes the fluid and pumps it to pressure chamber 28, which is fluidly coupled to spray tip assembly 22. Spray tip assembly 22 is either user-actuated or fluid-actuated to permit pressurized fluid through orifice 30, which atomizes the fluid for spraying.

Drive element 16 comprises a mechanism or motor for producing rotation of drive shaft 32. In the embodiment shown, drive element 16 comprises an electric motor and pumping mechanism 18 comprises a dual piston pump. Pumping mechanism 18 includes shaft 34, which is coupled to shaft 32 of drive element 16 through gear system 36. For example, gears 38, 40, 42 and 44, and shaft 46 provide a gear reduction means that slows the input to shaft 34 from the input provided by shaft 32. Specifically, shaft 32 rotates gear 38, which is engaged with gear 40 to rotate shaft 46. Shaft 46 rotates gear 42, which drives shaft 34 through gear 44. Rotation of shaft 34 produces wobble of hub 48. Operation of hub 48 is described further in U.S. Pat. App. Pub. No. 2012/0037726 to Johnson et al., which is assigned to Graco Minnesota Inc. and is incorporated by this reference.

Pistons 50 and 52 engage hub 48 such that wobble of hub 48 produces reciprocating motion of pistons 50 and 52. Piston 50 is disposed within cylinder 54 and piston 52 is disposed within cylinder 56. On a back stroke, piston 50 retreats within cylinder 54 via coupling to hub 48 to draw fluid from inlet tube 26 into cylinder 54 through port 57, while piston 52 simultaneously is pushed forward via engagement with hub 48 to push fluid from cylinder 56 and chamber 58 into pressure chamber 28, which serves as an outlet for pumping mechanism 18 and pump valve 20. On a forward stroke, piston 50 moves forward via coupling to hub 48 to push fluid from cylinder 54 into chamber 58 and cylinder 56 through porting in housing 12 (not shown), while piston 52 simultaneously is pushed backward via pressure within chamber 58 as fluid travels from chamber 58 into cylinder 56. To accommodate such volumetric flows, piston 50 has a displacement volume sufficient to fill both cylinder 56 and chamber 58. Pump valve 20 prevents fluid within chamber 58 from back flowing into cylinder 54. Inlet valve 59 prevents fluid within cylinder 54 from back flowing into inlet tube 26. Pressurized fluid from pressure chamber 28 flows into spray tip assembly 22, which includes actuation needle 60 that can be selectively actuated to allow pressurized fluid to flow through orifice 30. Operation of spray tip assembly 22 is described further in U.S. Pat. App. Pub. No. 2011/0198413 to Thompson et al., which is assigned to Graco Minnesota Inc. and is incorporated by this reference.

Portable airless sprayer 10 is configured to be able to spray fluids having different viscosities, fluids that are thick and fluids that are thin. For example, sprayer 10 may spray thick fluids such as coatings or epoxies, and sprayer 10 may be configured to spray thin fluids, such as paint and varnishes. Pump valve 20 is adjusted in order to configure sprayer 10 for different fluids by changing the amount that inlet check valve 59 is permitted to open. Pump valve 20 includes rod 62 and knob 64, and inlet check valve 59 includes spring 66, ball 68, seat 70 and collar 72. Pump valve 20 and inlet check valve 59 are shown and discussed in greater detail in International Publication Number WO 2013/090739, which is assigned to Graco Minnesota Inc. and is incorporated by this reference.

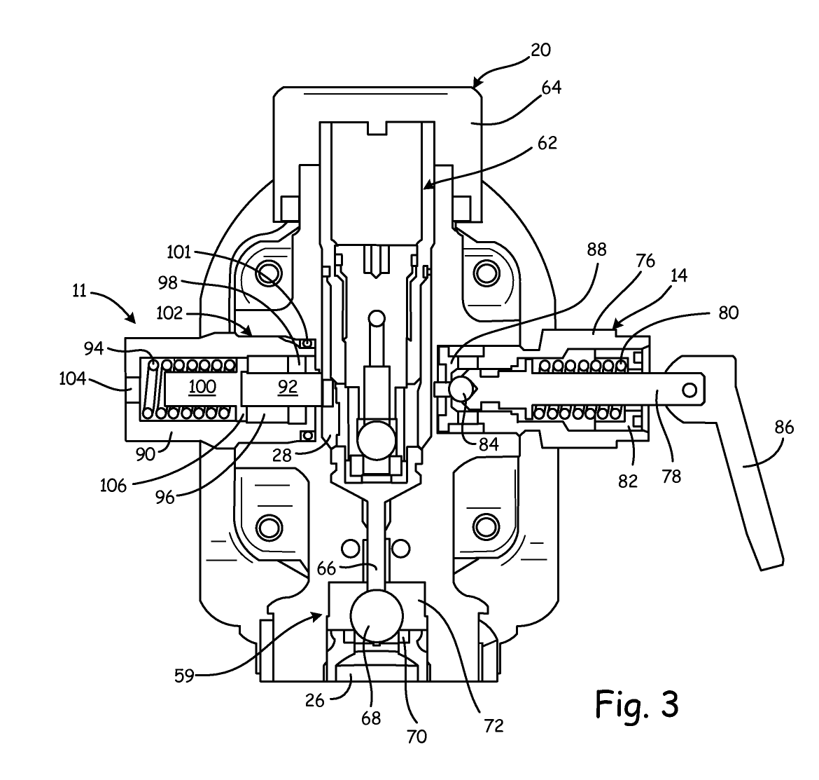

As is shown in FIG. 3, accumulator 11 is fluidly connected to chamber 58 between pressure chamber 28 and cylinders 54 and 56. Previous portable airless sprayers have utilized the area of pressure chamber 28 to provide a fixed-volume accumulator effect, such as is described in the aforementioned U.S. Pat. App. Pub. No. 2011/0198413. However, the accumulation effect provided by such a space is limited due to the fixed volume of pressure chamber 28 and the lack of independent pressure generation. The present disclosure utilizes an expandable volume that can independently generate pressurized fluid to spray tip assembly 22 to even-out pulsations in the discharge at orifice 30 that arise due to pumping fluctuations of pumping mechanism 18.

FIG. 3 is a front a cross-sectional view of pump valve 20 of FIG. 2 connected to a control valve 14 and accumulator 11. Control valve 14 includes housing 76, plunger 78, spring 80, cap 82, ball 84, lever 86 and gasket 88. Accumulator 11 comprises housing 90, piston 92, spring 94, bushing 96, seal 98 and guide 100.

Housing 76 of control valve 14 is threaded into housing 12 (FIG. 2) to intersect pressure chamber 28 and is therefore exposed to the fluid pressure generated by pumping mechanism 18. Housing 76 is also fluidly connected to container 24 (FIG. 1). As such, a complete fluid circuit is formed between fluid container 24, pumping mechanism 18, pressure chamber 28 and control valve 14. Spring 80 biases ball 84 against gasket 88 to close the fluid circuit. Lever 86 is actuated by an operator to connect fluid pressurized by pumping mechanism 18 to container 24. Thus, control valve 14 can be used to prime pumping mechanism by relieving air from the system, or to relieve high pressure fluid after a spraying operation is complete. Ball 84 may also be displaced from gasket 88 during overpressure conditions as a safety measure. Control valve 14 is shown and discussed in greater detail in International Publication Number WO 2012/097361, which is assigned to Graco Minnesota Inc. and is incorporated by this reference.

Housing 90 of accumulator 11 is connected to housing 12 of sprayer 10 at threaded connection 102. As such, the outer surface of housing 90 includes threads that engage with mating threads in housing 12. O-ring 101 is positioned between housing 90 and housing 12. Housing 90 comprises a cylindrical body having a closed end in which port 104 is located, and an open end that faces toward pressure chamber 28. Piston 92 and guide 100 are disposed within the interior space of housing 90. Piston 92 extends through the open end of housing 90 to engage pressure chamber 28. Guide 100 is connected to piston 92 and is disposed between piston 92 and port 104. Spring 94 is positioned around guide 100 and pushes against flange 106 to move piston 92 towards pressure chamber 28. In the embodiment shown, flange 106 extends from guide 100 and piston 92 is inserted into a socket within guide 100. Guide 100 ensures that spring 94 is properly aligned within housing 90 to push piston 92 in a linear direction and prevent binding. Bushing 96 is positioned around piston 92 and engages housing 90 to prevent piston 92 and guide 100 from leaving housing 90 through contact with flange 106. Thus, piston 92 is able to move or slide within bushing 96. Seal 98 prevents fluid within pressure chamber 28 from entering into housing 90. In one embodiment, seal 98 comprises a U-cup seal, although other seals may be used in other embodiments. However, any fluid that may leak into housing 90 is able to escape at port 104. Port 104 prevents hydraulic lock of accumulator 11, such as if the interior space of housing 90 were to fill with fluid that prevents movement of piston 92.

Accumulator 11 provides a volume of space that can be filled with fluid from pumping mechanism 18. Specifically, piston 92 occupies a volume within housing 90 that becomes filled with fluid as pressure chamber 28 becomes filled with pressurized fluid. The pressure of the fluid overcomes the force of spring 94 and displaces piston 92 into housing 90 to allow housing 90 to fill with pressurized fluid. The volume of fluid within housing 90 becomes additionally pressurized by the force of spring 94 acting upon piston 92. When pumping mechanism 18 reaches a state of low-pressure operation, such as a changeover position where pistons 50 and 52 (FIG. 2) reverse direction, piston 92 extends from housing 90 and acts upon the fluid within pressure chamber 28 to maintain pressure on the fluid. The pressure applied by spring 94 and piston 92 prevents the pressure within pressure chamber 28 from dropping to zero, which would otherwise occur for only a brief moment. To the extent accumulator 11 applies pressure to fluid above a zero pressure state, accumulator 11 reduces pulsation in fluid discharged at spray tip assembly 22. After accumulator 11 discharges the fluid within housing 90, pumping mechanism 18 returns to a high-pressure state that again pushes piston 92 back into housing 90 with pressurized fluid. As such, as pumping mechanism 18 cycles periodically through low-pressure and high-pressure states, accumulator 11 increases the pressure of the low-pressure state of sprayer 10 to reduce the effect of pulsations, which increases the spraying consistency of sprayer 10 and increases the capacity for an operator of sprayer 10 to apply an even finish.

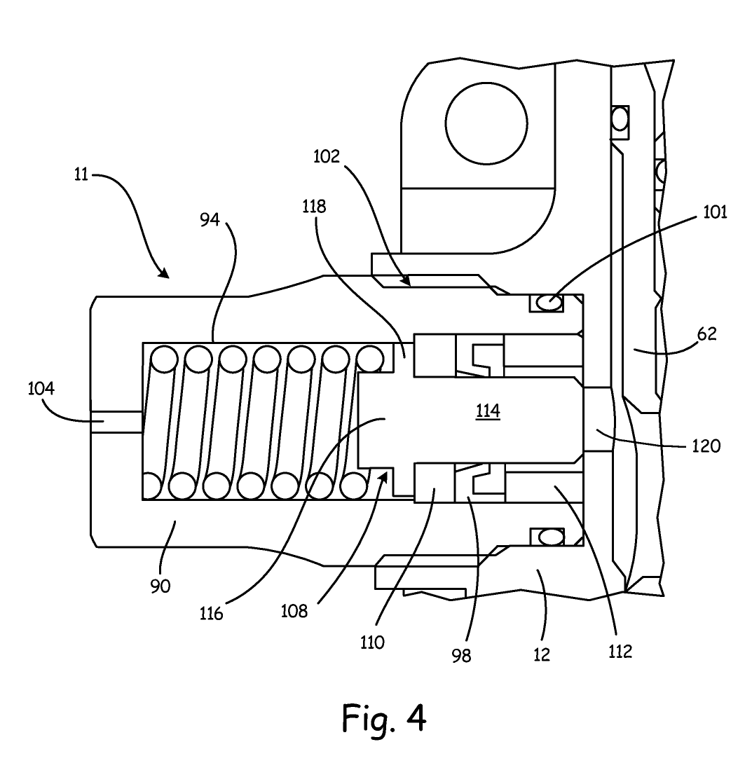

FIG. 4 is a cross-sectional view of an alternative embodiment of accumulator 11 of the present disclosure for use with portable airless sprayer 10. Accumulator 11 of FIG. 4 includes many of the same components as accumulator 11 of FIG. 3 and such components are numbered accordingly. However, in FIG. 4, accumulator 11 includes piston 108, bushing 110 and retainer ring 112. Piston 108 includes shaft 114, guide 116 and flange 118.

Piston 108 operates in a similar fashion as piston 92 and guide 100 of FIG. 3. However, shaft 114 and guide 116 of FIG. 4 are incorporated into a single-piece construction. Flange 118 is likewise incorporated into the single-piece construction to further reduce the number of components. Shaft 114, guide 116 and flange 118 engage bushing 110 and operate to apply pressurized fluid from the space within housing 90 to pressure chamber 28 through bore 120 in housing 12. The embodiment of FIG. 4 further includes retainer ring 112, which is used to prevent any of the components of accumulator 11 from leaving housing 90 and entering into housing 12. For example, retainer ring 112 maintains seal 98 engaged flush with bushing 110 to increasing sealing capabilities and prevent seal 98 from leaving housing 90. Retainer ring 112 further maintains accumulator assembled as a component that can be removed from housing 12 with separating into individual pieces. As such accumulator 11 can be easily removed from sprayer 10 and replaced.

Accumulators have finite useful fatigue lives because they include moving components that are subject to pressure. Accumulator 11 is readily accessible and can be removed from the sprayer without having to disassemble the sprayer. Additionally, accumulator 11 is conveniently packages in housing 90 so as to enable rapid replacement with a substitute accumulator. Alternatively, accumulator 11 can be quickly removed and disassembled with common hand tools, such as a screw driver, to facilitate rapid removal, disassembly, cleaning and reassembly.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An airless fluid dispensing device comprising:
a reciprocating fluid pump for directly pressurizing a fluid;
a drive element for supplying power to the pump;
a spray tip assembly configured to receive pressurized fluid from the pump;
an accumulator located to be simultaneously pressurized by the reciprocating fluid pump as the spray tip assembly and configured to provide pressurized fluid to the spray tip assembly when the reciprocating fluid pump is at a changeover position.

2. The airless fluid dispensing device of claim 1 wherein the accumulator comprises:
a piston that engages pressurized fluid in the airless fluid dispensing device; and
a spring that biases the piston toward the pressurized fluid.

3. The airless fluid dispensing device of claim 2 wherein the accumulator further comprises:
a cylindrical housing defining:
an internal space;
a closed end; and
an open end;
wherein the piston is disposed within the internal space and is capable of extending to the open end;
a flange extending from the piston, wherein the spring is disposed within the internal space and extends from the flange to the closed end;
a seal disposed around the piston within the internal space and positioned between the open end and the flange; and
a bushing surrounding the piston between the flange and the open end.

4. A hand held airless fluid dispensing device comprising:
a housing body configured to be carried and supported by an operator of the hand held airless fluid dispensing device during operation;
a fluid container supported by the housing body;
a pumping device mounted to the housing body;
a primary drive element coupled to the housing body and connected to the pumping device to actuate the pumping device;
a spray tip connected to an outlet of the pumping device; and
an accumulator disposed between the pumping device and the spray tip, the accumulator having a variable volume.

5. The hand held airless fluid dispensing device of claim 4 wherein the spray tip comprises:
a pressure actuated, spring-biased ball valve configured to open under pressurized fluid from the pumping mechanism; and
an orifice element connected to ball valve to atomize the pressurized fluid.

6. The hand held airless fluid dispensing device of claim 4 wherein the pumping device comprises:
a reciprocating piston fluid pump comprising at least two pumping chambers configured to be actuated out of phase by at least one piston.

7. The hand held airless fluid dispensing device of claim 4 wherein the accumulator is fluidly coupled to a pressure chamber disposed between the spray tip and the pumping device.

8. The hand held airless fluid dispensing device of claim 7 and further comprising:
a pump valve that fluidly couples the pumping device and the spray tip assembly; and
an inlet check valve fluidly coupling the fluid container to the pump valve, the pump valve controlling a distance that the inlet check valve opens;
wherein the accumulator is fluidly coupled to the pump valve.

9. The hand held airless fluid dispensing device of claim 7 wherein the accumulator comprises:
a piston that engages the pressure chamber; and
a spring that biases the piston toward the pressure chamber.

10. The hand held airless fluid dispensing device of claim 9 wherein the accumulator further comprises:
a cylinder attached to the housing and that defines space for the variable volume, the piston being disposed in the space;
wherein the spring is disposed within the space between the piston and the cylinder.

11. The hand held airless fluid dispensing device of claim 10 wherein the accumulator further comprises:
a bushing surrounding the piston; and
a seal surrounding the piston between the bushing and the pressure chamber.

12. The hand held airless fluid dispensing device of claim 11 and further comprising:
a retainer disposed in the cylinder to prevent the seal from entering the pressure chamber.

13. The hand held airless fluid dispensing device of claim 10 and further comprising:
a spring guide extending from the piston into the cylinder; and
a flange extending from the spring guide or the piston to transfer force from the spring to the piston.

14. The hand held airless fluid dispensing device of claim 10 and further comprising:
a bleed port located in the cylinder aft of the piston.

15. A detachable accumulator device comprising:
a cylindrical housing defining:
an internal space;
a closed end; and
an open end;
a piston disposed within the internal space and capable of extending to the open end;
a flange extending from the piston;
a spring disposed within the internal space and extending from the flange to the closed end;
a seal disposed around the piston within the internal space and positioned between the open end and the flange; and
a bushing surrounding the piston between the flange and the open end.

16. The detachable accumulator device of claim 15 and further comprising:
a bleed port located in the closed end of the cylindrical housing.

17. The detachable accumulator device of claim 15 and further comprising:
threads located on an exterior of the cylindrical housing proximate the open end; and
a seal disposed about the cylindrical housing between the open end and the threads.

18. The detachable accumulator device of claim 15 and further comprising:
a retainer ring disposed within the internal space between the open end and the seal to prevent the seal from leaving the open end.

19. The detachable accumulator device of claim 15 wherein the piston comprises:
a shaft around which the seal and bushing are located; and
a spring guide extending from shaft toward the closed end;
wherein the flange extends from the piston between the shaft and the spring guide.

20. The detachable accumulator device of claim 15 wherein the piston comprises:
a shaft around which the seal and bushing are located; and
a spring guide attached to an end of the shaft;
wherein the flange extends from the spring guide proximate the shaft.
